(19) United States
(12) Patent Application Publication
(10) Pub. No.: US 2026/0097722 A1
(43) Pub. Date: Apr. 9, 2026

(54) METHOD AND SYSTEM FOR INSTALLING WIRING HARNESS INTO VEHICLE

(71) Applicant: Ford Global Technologies, LLC, Dearborn, MI (US)

(72) Inventors: Jon Arthur Zimmerman, Ferndale, MI (US); Kurt Michael Lundeen, Novi, MI (US); Zachary James Kadykowski, Chelsea, MI (US); Olaf Salomao Erdmann, Rochester Hills, MI (US); John Randolf Vincent, Livonia, MI (US); Derrick Miller, Ypsilanti, MI (US); Andrei Negrus, Prospect, KY (US)

(73) Assignee: Ford Global Technologies, LLC, Dearborn, MI (US)

(21) Appl. No.: 18/909,197

(22) Filed: Oct. 8, 2024

(51) Int. Cl. B60R 16/02; H01B 7/00; H02G 1/06

(52) U.S. Cl. CPC B60R 16/0215; H02G 1/06; H01B 7/0045

(57) ABSTRACT

A method for installing a wiring harness into a vehicle including coupling at least one module and the wiring harness to a fixture to form a structure, moving the structure to the vehicle, decoupling the module and the wiring harness from the fixture, coupling the module and the wiring harness to the vehicle, and removing the fixture from the vehicle.

### FIELD

The present disclosure relates to a method and system for installing a wiring harness into a vehicle.

### BACKGROUND

The statements in this section merely provide background information related to the present disclosure and may not constitute prior art.

Industrial robots have been used for a variety of manufacturing operations, including by way of example, welding and moving parts from one location to another such as retrieving parts from a storage location and moving them to an assembly station. Automating the moving of some vehicle parts such as wire harnesses, for example, may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, the present disclosure provides a method for installing a wiring harness into a vehicle. The method includes coupling at least one module and the wiring harness to a fixture to form a structure, moving the structure to the vehicle, decoupling the module and the wiring harness from the fixture, coupling the module and the wiring harness to the vehicle, and removing the fixture from the vehicle.

In variations of the method of the above paragraph, which can be implemented individually or in any combination: the method further includes decoupling the module and the wiring harness from the fixture and coupling the module and the wiring harness to the vehicle simultaneously; connecting at least one connector of the wiring harness to at least one terminal of the module prior to moving the structure to the vehicle; aligning the wiring harness and the module within the vehicle after moving the structure to the vehicle; the structure is a rigid structure; coupling the module and the wiring harness to the vehicle includes mounting the module and the wiring harness to mounting features of the vehicle; coupling the module and the wiring harness to the fixture occurs at a first location; coupling the module and the wiring harness to the vehicle occurs at a second location, the first location is different than the second location; coupling the module and the wiring harness to the vehicle includes coupling the module and a first portion of the wiring harness to a first location of the vehicle and coupling a second portion of the wiring harness to a second location of the vehicle after the module and the first portion of the wiring harness has been coupled to the first location of the vehicle; and the first location of the vehicle is a rear region of the vehicle and the second location of the vehicle is a side region of the vehicle.

In another form, the present disclosure provides a method for installing a wiring harness into a vehicle. The method includes coupling a plurality of modules and the wiring harness to a fixture to form a rigid structure, moving the rigid structure to the vehicle, decoupling the plurality of modules and the wiring harness from the fixture, coupling the plurality of modules and the wiring harness to the vehicle, and removing the fixture from the vehicle. Coupling the plurality of modules and the wiring harness to the vehicle includes coupling the plurality of modules and a first portion of the wiring harness to a first location of the vehicle and coupling a second portion of the wiring harness to a second location of the vehicle.

In variations of the method of the above paragraph, which can be implemented individually or in any combination: decoupling the plurality of modules and the wiring harness from the fixture and coupling the plurality of modules and the wiring harness to the vehicle occur simultaneously; connecting at least one connector of the wiring harness to a corresponding terminal of one module of the plurality modules prior to moving the rigid structure to the vehicle; aligning the wiring harness and the plurality of modules within the vehicle after moving the rigid structure to the vehicle; coupling the plurality of modules and the wiring harness to the vehicle includes mounting the plurality of modules and the wiring harness to mounting features of the vehicle; the first location is different than the second location; and the second portion of the wiring harness is coupled to the second location of the vehicle after the plurality of modules and the first portion of the wiring harness has been coupled to the first location of the vehicle.

In yet another form, the present disclosure provides a system for installing a wiring harness into a vehicle. The system includes a fixture, at least one robot, and a controller. The fixture includes at least one module coupled thereto. The controller is in communication with the robot and is configured to: instruct the robot to couple the wiring harness to the fixture including the at least one module to form a structure, instruct the robot to move the structure to the vehicle, instruct the robot to decouple the module and the wiring harness from the fixture, instruct the robot to couple the module and the wiring harness to the vehicle, and instruct the robot to move the fixture from the vehicle.

In variations of the system of the above paragraph, which can be implemented individually or in any combination: rigid structure; the robot includes a first robot configured to couple the wiring harness to the fixture, and a second robot configured to move the structure to the vehicle; and coupling the module and the wiring harness to the vehicle includes coupling the module and a first portion of the wiring harness to a first location of the vehicle and coupling a second portion of the wiring harness to a second location of the vehicle after the module and the first portion of the wiring harness has been coupled to the first location of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a system for handling components of a vehicle according to the principles of the present disclosure with a wire harness component of the components being disposed on a work surface;

FIG. 1B is a perspective view of the components secured to a vehicle according to the principles of the present disclosure;

FIG. 2 is a perspective view of a fixture of the system of FIG. 1A;

FIG. 3 is a perspective view of a wire harness component shown in FIG. 1A secured to the fixture;

FIGS. 4A and 4B are perspective views of one robot detaching one section of the wire harness component of FIG. 1 from another section and moving the section to the fixture;

FIG. 5 is a perspective view of an electrical connector of the wire harness component of FIG. 1 being connected to a vehicle module component of the vehicle;

FIG. 6 is a perspective view of the electrical connector of the wire harness component of FIG. 1 connected to the vehicle module component of the vehicle;

FIG. 7 is a perspective view of another robot of the system of FIG. 1 moving a structure including the components and the fixture to the vehicle according to the principles of the present disclosure;

FIG. 8 is a perspective view of the robot of FIG. 7 aligning the components of the structure to the vehicle;

FIGS. 9A and 9B are perspective views of the robot of FIG. 7 coupling the components to the vehicle;

FIG. 10 is a perspective of the robot of FIG. 7 moving the fixture of FIG. 2 back to the work surface;

FIG. 11 is a schematic block diagram showing components of the system of FIGS. 1A and 1B in accordance with the teachings of the present disclosure; and

FIG. 12 is a flowchart depicting an algorithm for handling components of the system of FIGS. 1A and 1B in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

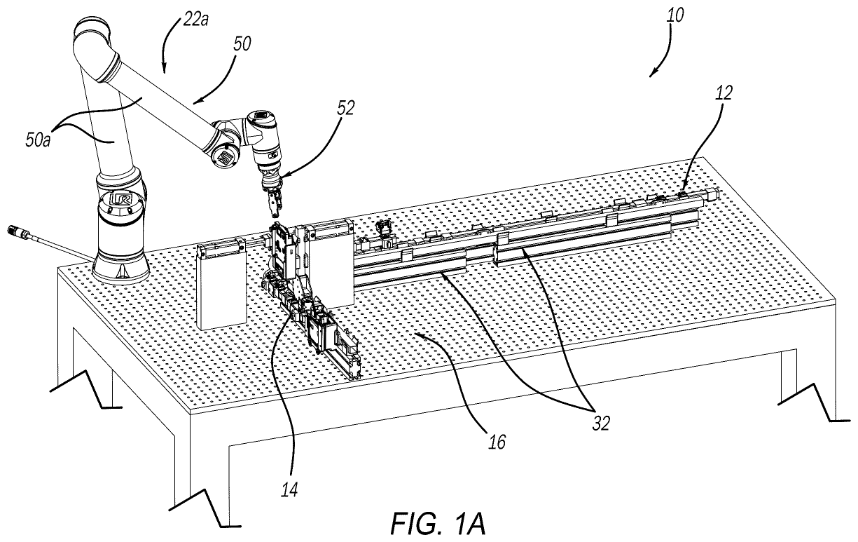

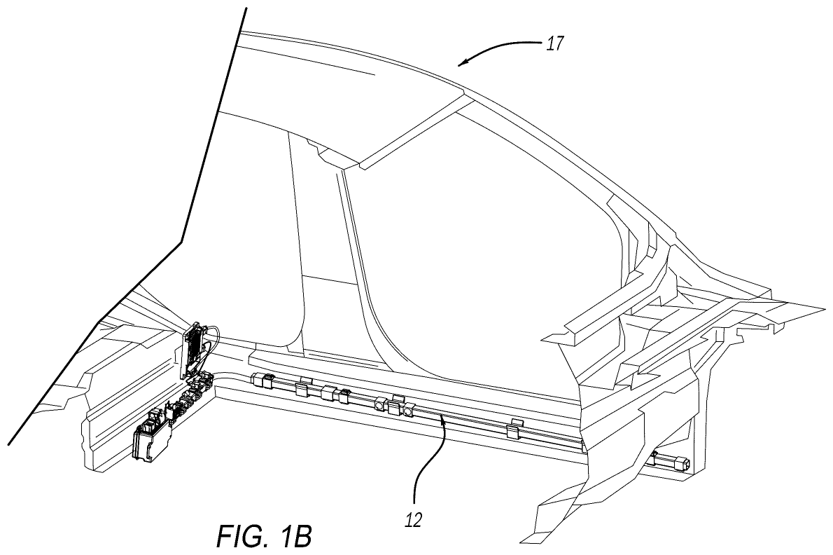

With reference to FIG. 1A, a system 10 for handling one or more vehicle components 12 is illustrated. The handling of the vehicle components 12 may include retrieving the vehicle components 12 from a part support (e.g., a dunnage rack), placing the vehicle components 12 onto a work surface 16, manipulating parts of the vehicle components 12 on the work surface 16, and/or installing the vehicle components 12 into a machine 17 (e.g., a vehicle). The system 10 allows for the handling of the vehicle components 12 with little to no human intervention. In this way, the handling of the vehicle components 12 may be automated to increase productivity, reduce cycle time, and reduce variation and error, for example. In the example illustrated, the vehicle components 12 include electrical components such as wire harnesses. That is, wire harnesses tend to be flexible, complex, and highly variable from one part to the next, so that installation of the wire harness into the machine 17 may be challenging to automate. The system 10 of the present disclosure provides for the adaptation of vehicle components 12 such as wire harnesses to better support automation. It should be understood that the vehicle components 12 may be other components of a vehicle other than wire harnesses.

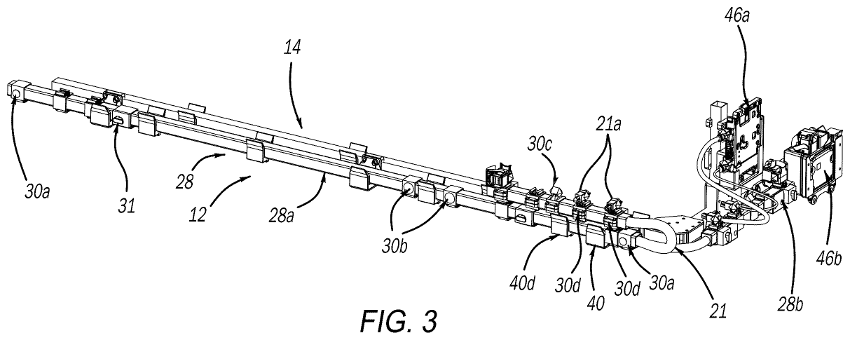

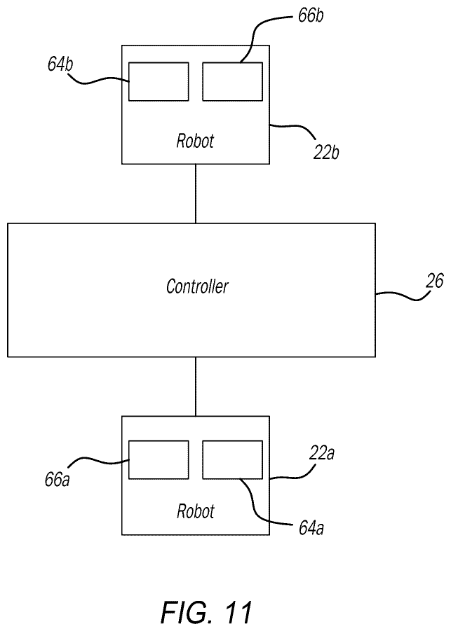

With reference to FIG. 1A, the system 10 may include the vehicle components 12 (only one shown in the figures), a fixture 14, one or more robots 22a, 22b, and a controller 26 (FIG. 11). Each vehicle component 12 may be moved to the fixture 14 from the part support (not shown). One example of a system for moving the vehicle component 12 from the part support to the fixture 14 is disclosed in U.S. Patent App. No. XX/000,000, and titled “SYSTEM FOR HANDLING A COMPONENT OF A VEHICLE” which is commonly owned with the present application and the contents of which are incorporated herein by reference in its entirety. With reference to FIG. 3, each vehicle component 12 includes a body or housing 28 and a plurality of collars 30a, 30b, 30c, 30d, 31a, 31b. The body 28 may be made of a rigid material (e.g., metal or plastic) and may house electrical components 21 (e.g., flexible wires). In the example illustrated, the body 28 is hollow and has a square shape. In some forms, the body 28 may have a circular shape, rectangular shape, or any other suitable shape that may be house electrical components.

In the example illustrated, the body 28 includes multiple sections 28a, 28b that are movable relative to each other. For example, the sections 28a, 28b may be coupled to each other (e.g., folding onto each other) as the vehicle component 12 moves from the part support (not shown) to the fixture 14. In this way, moving the vehicle component 12 to the fixture 14 is facilitated. Once the vehicle component 12 is coupled to the fixture 14, the sections 28a, 28b of the vehicle component 12 may be decoupled from each other (e.g., unfolded from each other) using the robot 22a and positioned at predetermined positions with respect to each other for further processing. In the example illustrated, the section 28b of the vehicle component 12 is decoupled or detached from the section 28a and positioned with respect to the section 28a once the vehicle component 12 is coupled to the fixture 14. The section 28b may be positioned at a perpendicular angel, obtuse angle or acute angle, for example, with respect to the section 28a.

In the example illustrated, the sections 28a, 28b may be spaced apart from each other once the vehicle component 12 is coupled to the fixture 14. In the example illustrated, the section 28a of the vehicle component 12 has a length that is greater than a length of the section 28b of the vehicle component 12. In some forms, the section 28a of the vehicle component 12 may have a length that is equal to or less than a length of the section 28b of the vehicle component 12. It should be understood that the electrical components (e.g., wires) extend through the sections 28a, 28b of the body 28 and may have ends that are secured to the body 28 as will be described in greater detail below. It should also be understood that although the present disclosure discloses the body 28 having two sections 28a, 28b movable relative to each other, the body 28 may include more than two sections movable relative to each other without departing from the scope of the present disclosure.

The collars 30a may be coupled at opposing ends of the section 28a of the vehicle component 12 and may be configured to attach the vehicle component 12 to the part support (not shown). One example of such collar is disclosed in U.S. Patent App. No. XX/000,000, and titled “SYSTEM FOR HANDLING A COMPONENT OF A VEHICLE” which is commonly owned with the present application and the contents of which are incorporated herein by reference in its entirety. The collars 30b may be coupled to the section 28a of the vehicle component 12 between the collars 30a and may be configured to allow a robot (not shown) to grasp the vehicle component 12 for moving from the part support to the fixture 14. One example of such collar is disclosed in U.S. Patent App. No. XX/000,000, and titled “SYSTEM FOR HANDLING A COMPONENT OF A VEHICLE” which is commonly owned with the present application and the contents of which are incorporated herein by reference in its entirety.

One or more collars 30c may be coupled to the section 28b of the vehicle component 12 and may be configured to allow the robot 22a to grasp the section 28b of the vehicle component 12 and decouple the section 28b from the section 28a. One example of such collar is disclosed in U.S. Patent App. No. XX/000,000, and titled “SYSTEM FOR HANDLING ELECTRICAL COMPONENTS OF A VEHICLE” which is commonly owned with the present application and the contents of which are incorporated herein by reference in its entirety. One or more collars 30d may be coupled to a corresponding section 28a, 28b of the vehicle component 12 and may be configured to removably couple connectors 21a of the electrical components 21 to the body 28 of the vehicle component 12. In the example illustrated, the collars 30d are coupled to the section 28b of the vehicle component 12 and may couple connectors 21a of the electrical components 21 to the section 28b. In this way, the connectors 21a are secured to the body 28 as the vehicle component 12 is moved from the part support (not shown) to the fixture 14 and as the section 28b is separated from the section 28a as described above. One example of such collar is disclosed in U.S. Patent App. No. XX/000,000, and titled “SYSTEM FOR HANDLING ELECTRICAL COMPONENTS OF A VEHICLE” which is commonly owned with the present application and the contents of which are incorporated herein by reference in its entirety.

The collars 31 may be coupled to the sections 28a, 28b of the vehicle component 12 and may be configured to attach the vehicle component 12 to the machine 17. The collars 31 may include one or more of clips, tabs, fasteners to attach the vehicle component 12 to the machine 17. In one form, the collars 31 may attach the vehicle component 12 to different areas of the machine 17. In the example illustrated, the collars 31 attach the vehicle component 12 to a side area (e.g., rocker) of the machine 17 and a rear area of the machine 17. It should also be understood that the collars 31 may attach the vehicle component 12 to a front area of the machine 17 and/or a floor area of the machine 17, for example. One example of such collar is disclosed in U.S. Patent App. No. XX/000,000, and titled “RETENTION ASSEMBLY FOR COUPLING WIRING HARNESS TO VEHICLE HAVING ELECTRICAL GROUND” which is commonly owned with the present application and the contents of which are incorporated herein by reference in its entirety.

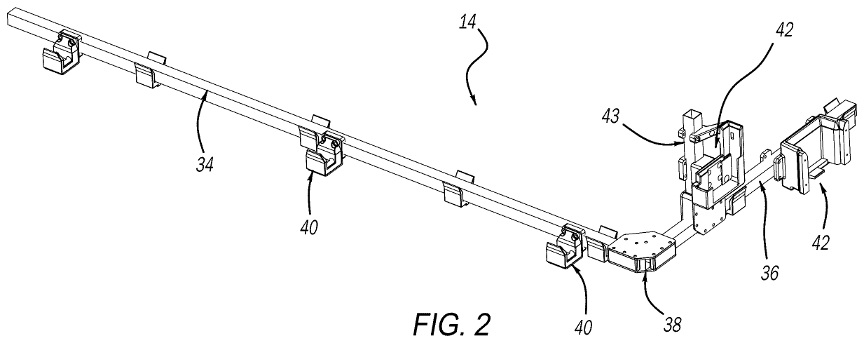

With reference to FIGS. 2 and 3, the fixture 14 is removably coupled to the work surface 16 such that the fixture 14 may be graspable by the robot 22b. That is, the fixture 14 may be supported on one or more rails or beams 32 that may be secured to the work surface 16 such that the fixture 14 is spaced apart from the work surface 16, thereby allowing the robot 22b to grasp the fixture 14 and remove it from the work surface 16 as will be described in more detail below. In some forms, the fixture 14 may be removably coupled directly to the work surface 16. The fixture 14 includes a first component 34, a second component 36, an intermediate component 38, a plurality of brackets or retaining features 40, and a plurality of module supports 42.

The first component 34 may be made of a rigid material (e.g., metal or plastic) and may support the vehicle component 12 (e.g., the section 28a of the vehicle component 12) when the vehicle component 12 is moved to the work surface 16. In the example illustrated, the first component 34 has a square shape. In some forms, the first component 34 may have a circular shape, rectangular shape, or any other suitable shape that may support the vehicle component 12. In some forms, the first component 34 may be solid. In other forms, the first component 34 may be hollow to reduce weight of the fixture 14. The second component 36 may be made of a rigid component (e.g., metal or plastic) and may support the vehicle component 12 (e.g., the section 28b of the vehicle component 12) when the vehicle component 12 is moved to the work surface 16. In the example illustrated, the first component 34 has a length that is greater than a length of the second component 36. In some forms, the first component 34 may have a length that is equal to or less than a length of the second component 36. In the example illustrated, the second component 36 has a square shape. In some forms, the second component 36 may have a circular shape, rectangular shape, or any other suitable shape that may support the vehicle component 12. In some forms, the second component 36 may be solid. In other forms, the second component 36 may be hollow to reduce weight of the fixture 14. In the example illustrated, the second component 36 extends in a different direction than the first component 34. In some forms, the first and second components 34, 36 may extend in the same direction. Although the first and second components 34, 36 are shown having the same shape, it should be understood that, in some configurations, the first and second components 34, 36 may have different shapes to support different portions of the vehicle components 12 or parts secured to the fixture 14.

The intermediate component 38 is positioned between the first component 34 and the second component 36 and may direct and support a portion of the electrical components 21. In this way, the electrical components 21 are inhibited from being entangled as the fixture 14 and the vehicle component 12 are being moved from the work surface 16 to the machine 17, for example. In the example illustrated, the intermediate component 38 has a polygonal shape having a plurality of flat sides. In this way, when the vehicle component 12 is coupled to the fixture 14, the sections 28a, 28b may engage flat sides of the intermediate component 38. In some forms, the intermediate component 38 may include a circular or arcuate shape. In the example illustrated, the intermediate component 38 is located at a corner of the fixture 14 where the first and second components 34, 36 extend in different directions. In this way, electrical components 21 and the first and second components 34, 36 may be supported. The intermediate component 38 is also secured to the first and second components 34, 36 via welding, fasteners, or adhesives, for example.

The plurality of brackets 40 are secured to first and second components 34, 36 and may include openings that are configured to receive the vehicle component 12, thereby coupling the vehicle component 12 to the fixture 14. The brackets 40 are spaced apart from each other and may be disposed between one or more collars. In the example illustrated, each bracket 40 may include two shells or halves that are secured to the components 34, 36 via fasteners. In some forms, the components 34, 36 may be manufactured (e.g., additively manufactured or injection molded) as a single, monolith component to include the brackets 40. Each opening includes a first or insertion portion and a second or retaining portion. The first portion is where the vehicle component 12 is inserted into the bracket 40. The second portion is where the vehicle component 12 is retained in the bracket 40. That is, the vehicle component 12 may be inhibited from moving laterally when in the second portion and may be inhibited from moving downward when in the second portion. Gravity inhibits the vehicle component 12 from moving upward when in the second portion of the opening. In the example illustrated, the first portion is tapered to the second portion. In this way, the first portion may accommodate error or misalignment in the vehicle component 12 initial positioning by the robot (not shown). When the sections 28a, 28b of the vehicle component 12 are received in the second portion of the brackets 40, the sections 28a, 28b are positioned relative to and spaced apart from the first and second components 34, 36 of the fixture 14.

Each module support 42 is secured to a corresponding section 28a, 28b of the fixture 14 and may be configured to retain a respective vehicle module 46a, 46b. In one example, the vehicle module 46a, 46b may be an engine control module that controls multiple systems of an internal combustion engine. In another example, the vehicle module 46a, 46b may be a suspension module that controls the suspension and adjust the tension for each wheel independently. It should be understood that the module supports 42 may support other vehicle modules for the machine 17.

Each module support 42 includes a structure or receptacle that the vehicle module 46a, 46b may be coupled thereto. A robot (not shown) may couple the vehicle module 46a, 46b to the module support 42 with little to no human intervention, thereby increasing productivity, and reducing cycle time, for example. In the example illustrated, the module supports 42 are secured to the second component 36 of the fixture 14 (e.g., by fasteners). In some forms, the module supports 42 may be secured to the first component 34 of the fixture 14. In other forms, one or more module supports 42 may be secured to the first component 34 of the fixture 14 and one or more module supports 42 may be secured to the second component 36 of the fixture 14. Some module supports 42 may be secured directly to the components 34, 36 and some module supports 42 may be secured to a post or beam 43, which, in turn, is secured directly to the components 34, 36 In this way, the vehicle modules 46a, 46b may be located at different locations and angles relative to each other along the fixture 14. It should be understood that the vehicle modules 46a, 46b are coupled to the module supports 42 so that the vehicle modules 46a, 46b are inhibited from moving relative to the fixture 14 as the fixture 14 is moving from the work surface 16 to the machine 17 via the robot 22b as will be described in greater detail below.

With reference to FIGS. 1A, 4A, 4B, 5 and 6, the robot 22a is configured to detach the sections 28a, 28b of the vehicle component 12 from each other on the work surface 16 and connect the connectors 21a of the electrical components 21 to terminals 53 of the vehicle modules 46a, 46b. The robot 22a includes a robot arm 50 and a robotic gripper structure or apparatus 52. The robot arm 50 includes a plurality of segments 50a connected to each other at joints, thereby allowing the robot 22a to have multiple degrees of freedom. The robot arm 50 is also secured to the work surface 16 at a first end. In some variations, the robot arm 50 includes an optional adapter (not shown) that is adapted to be secured to the work surface 16. In some forms, the robot 22a is separate from the work surface 16 and is partially or fully autonomous and is configured to autonomously move to the work surface 16 as instructed by the controller 26. To autonomously move itself, the controller 26 is configured to control various movement systems of the robot 22a based on location data obtained from one or more sensors. In an example application, the movement systems may include propulsion systems, steering systems for controlling wheels, and the sensors for providing location data may include a GNSS sensor, an imaging sensor, a local position sensor, among others.

The robotic gripper structure 52 is secured to the robot arm 50 and is configured to grasp and move the sections 28a, 28b of the vehicle component 12. One example of such collar is disclosed in U.S. Patent App. No. XX/000,000, and titled “SYSTEM FOR HANDLING ELECTRICAL COMPONENTS OF A VEHICLE” which is commonly owned with the present application and the contents of which are incorporated herein by reference in its entirety.

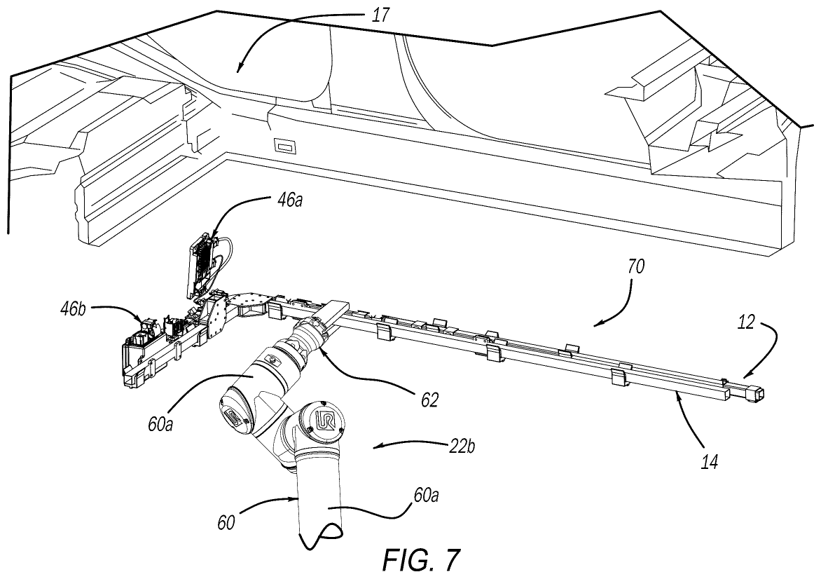

With reference to FIGS. 7, 8, 9A and 9B, the robot 22b is configured to move the fixture 14 and the vehicle component 12 from the work surface 16 to the machine 17, and couple the vehicle component 12 and the control modules 46a, 46b to the machine 17. That is, the robot 22b engages the fixture 14 to move the fixture 14 and the vehicle components 12 coupled thereto from the work surface 16 to the machine 17. The robot 22b includes a robot arm 60 and a robotic gripper structure or apparatus 62. The robot arm 60 includes a plurality of segments 60a connected to each other at joints, thereby allowing the robot 22b to have multiple degrees of freedom. In some forms, the robot 22b is separate from the work surface 16 and is partially or fully autonomous and is configured to autonomously move to the work surface 16 as instructed by the controller 26. To autonomously move itself, the controller 26 is configured to control various movement systems of the robot 22b based on location data obtained from one or more sensors. In an example application, the movement systems may include propulsion systems, steering systems for controlling wheels, and the sensors for providing location data may include a GNSS sensor, an imaging sensor, a local position sensor, among others. The robotic gripper structure 62 is secured to the robot arm 60 and is configured to grasp and move the fixture 14 from the work surface 16 to a final vehicle assembly line 76.

With reference to FIG. 11, the controller 26 is in communication with the robots 22a, 22b and may monitor and control operations of the robots 22a, 22b based on data received. In one example, the controller 26 is in communication with the robots 22a, 22b using a wired or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

The system 10 further includes vision sensors 64a, 64b. The vision sensors 64a, 64b are disposed on respective robots 22a, 22b, respectively, for example, and may be in communication with the controller 26 using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). Each vision sensor 64a, 64b collects visual image data and transmits the data to the controller 26. Based on the visual image data, the controller 26 provides instructions to the robots 22a, 22b to operate the robots 22a, 22b. More specifically, the controller 26 provides instructions to operate the robots 22a, 22b to move the sections 28a, 28b of the vehicle component 12 relative to each other and to move the fixture 14, the vehicle component 12, and the control modules 46a, 46b to the machine 17 based on the visual image data collected by the vision sensors 64a, 64b.

In one form, the vision sensors 64a, 64b are configured with an object detection algorithm trained to identify the collars 30c, 30d on the vehicle component 12, and mounting features associated with the machine 17 based on images collected by the vision sensors 64a, 64b. The object detection algorithm is an image processing technique, such as Canny edge detection or deep learning. In another form, the controller 26 is configured with the object detection algorithm and, based on data from a localization system (not shown), locates the collars 30c, 30d on the vehicle component 12 and the mounting features of the machine 17 based on the image data. In one form, the visual image data includes coordinate data, such as two-dimensional or three-dimensional coordinate data, that the localization system is configured to process into a global coordinate system. Based on the localizing performed by the localization system, the controller 26 is configured to identify objects and locations of objects in the visual image data.

The system 10 may further includes sensors 66a, 66b. The sensors 66a, 66b may be associated with respective robots 22a, 22b (e.g., disposed on), respectively, for example, and may be in communication with the controller 26 using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). Each sensor 66a, 66b measures force or pressure applied to the robots 22a, 22b and transmits the data to the controller 26. Based on the force or pressure data, the controller 26 provides instructions to the robots 22a, 22b to operate the robots 22a, 22b.

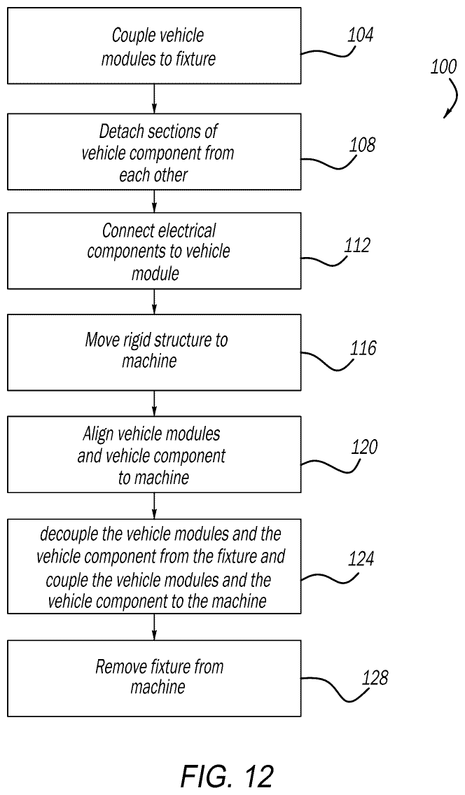

Referring to FIG. 12, an example control algorithm 100 for moving the sections 28a, 28b of the vehicle component 12 relative to each other and moving the vehicle component 12, the fixture 14, and the control modules 46a, 46b to the machine 17 is illustrated. The processing may begin once the vehicle component 12 is moved from the part support (not shown) to the fixture 14 as described above. At 104, the control algorithm, using the controller 26, instructs a robot (not shown) to couple one or more vehicle modules 46a, 46b to the fixture 14. It should be understood that the vehicle modules 46a, 46b may be coupled to the fixture 14 prior to the vehicle component 12 being moved to the fixture 14 or after the vehicle component 12 is moved to the fixture 14. It should also be understood that one of the robots 22a, 22b may couple the vehicle modules 46a, 46b to the fixture 14.

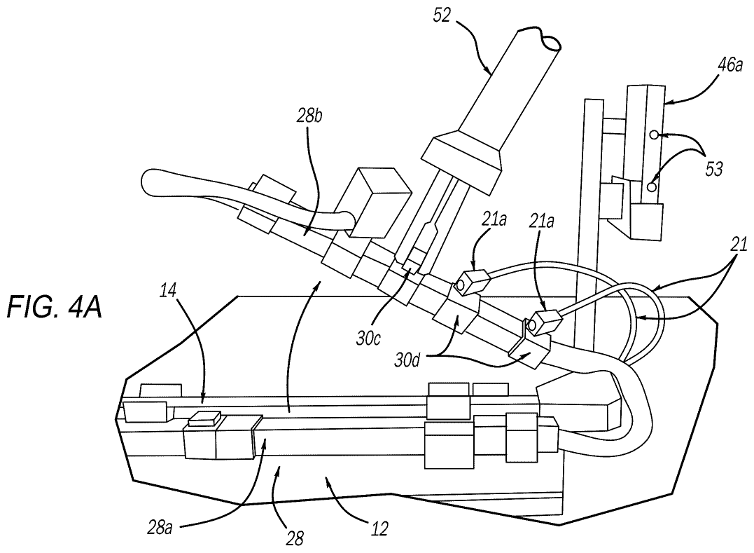

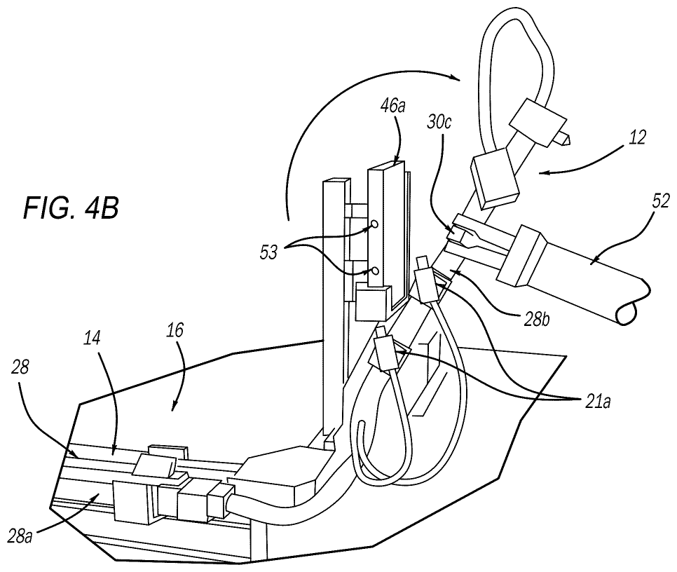

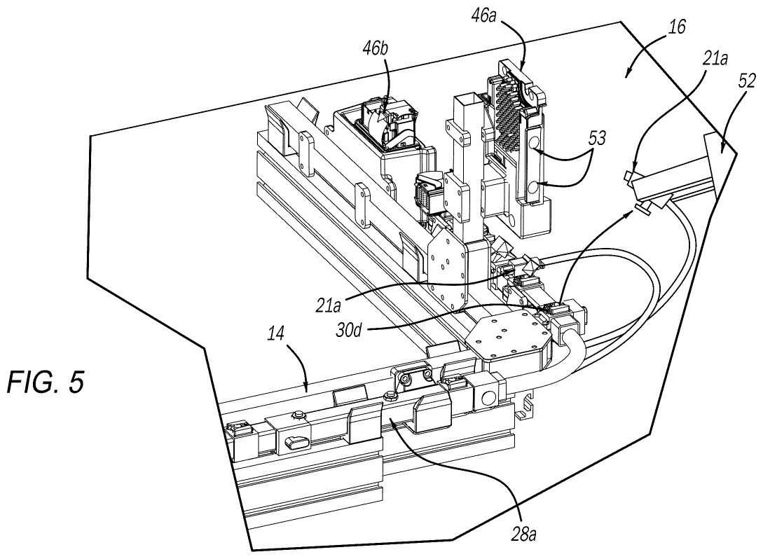

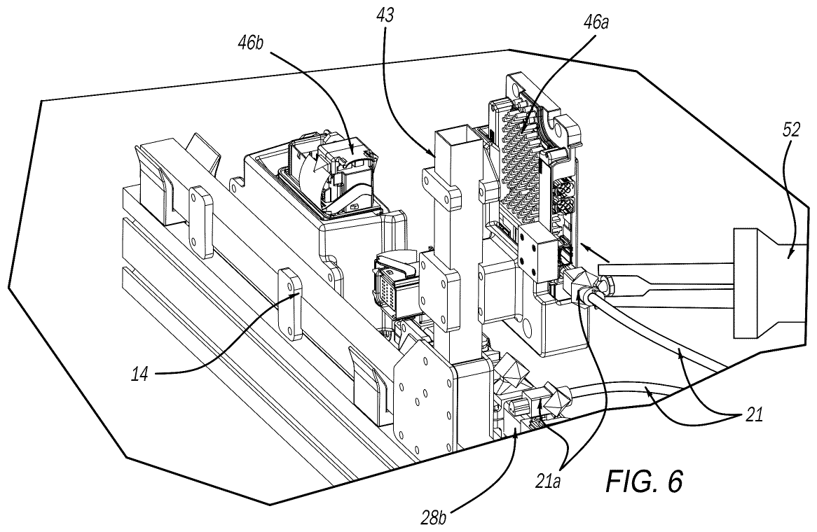

At 108, the control algorithm, using the controller 26, instructs the robot 22a to unfold or detach the sections 28a, 28b of the vehicle component 12 from each other (FIGS. 4A and 4B). That is, the sections 28a, 28b may be folded onto or attached to each other during transport from the part support (not shown) to the fixture 14 to facilitate transport. Once the vehicle component 12 is coupled to the fixture 14, the sections 28a, 28b may be detached for further processing of the vehicle component 12. At 112, the control algorithm, using the controller 26, instructs the robot 22a to connect one or more connectors 21a of the electrical components 21 to respective terminals 53 of the vehicle modules 46a, 46b (FIGS. 5 and 6). In this way, the electrical components 21 are electrically connected to the vehicle modules 46a, 46b. It should be understood that the vision sensors 64a and the sensors 66a may facilitate connecting the connectors 21a to the respective terminals 53 of the vehicle modules 46a, 46b. Once the connectors 21a are connected to the respective terminals 53, the fixture 14, the vehicle modules 46a, 46b, and the vehicle component 12 form a rigid structure 70.

At 116, the control algorithm, using the controller 26, instructs the robot 22b to move the rigid structure 70 to the machine 17 (FIG. 7). In this way, the parts (e.g., connectors 21a, the vehicle modules 46a, 46b, the vehicle component 12, the fixture 14) of the rigid structure 70 are held in place during movement of the rigid structure 70 to the machine 17. That is, the rigid structure 70 is formed at the work surface 16 that may be remote (e.g., at a different location) from the final vehicle assembly line where the machine 17 is located. In this way, the rigid structure 70 may be built up off the final vehicle assembly line and then moved to the machine 17 on the final vehicle assembly line. The buildup of the electrical component 21 and the vehicle modules 46a, 46b onto the fixture 14 offline allows for longer cycle times for each robotic operation, thereby providing the use of smaller robots. The buildup of the electrical component 21 and the vehicle modules 46a, 46b onto the fixture 14 offline also allows for verification of the electrical connections offline, thereby inhibiting rework on the final vehicle assembly line. The buildup of the electrical component 21 and the vehicle modules 46a, 46b onto the fixture 14 offline further inhibits the electrical components from being entangled with features and parts on the machine 17.

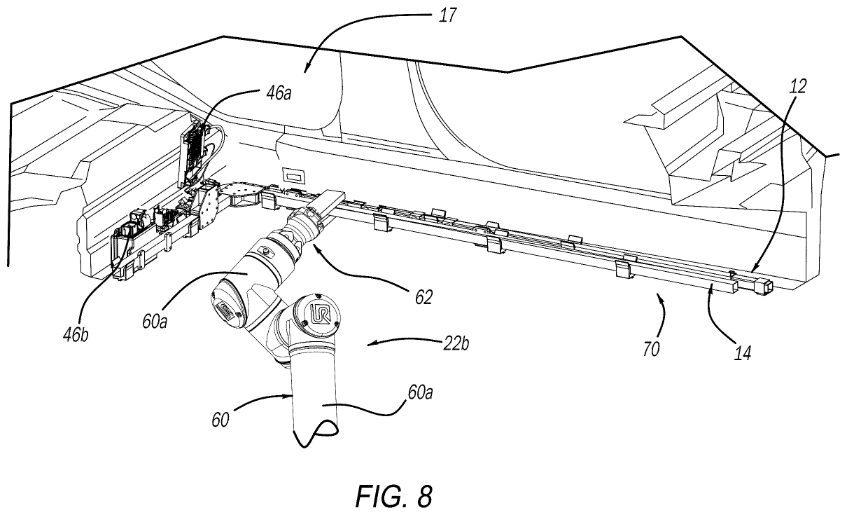

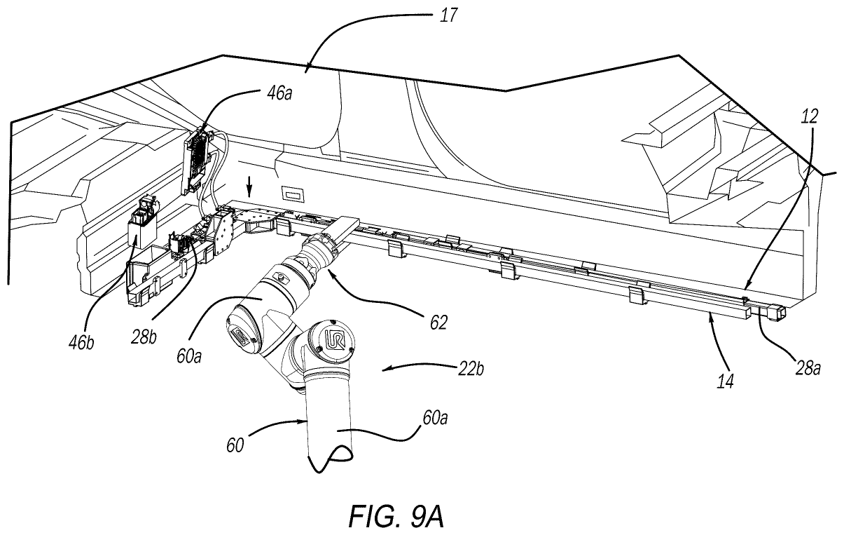

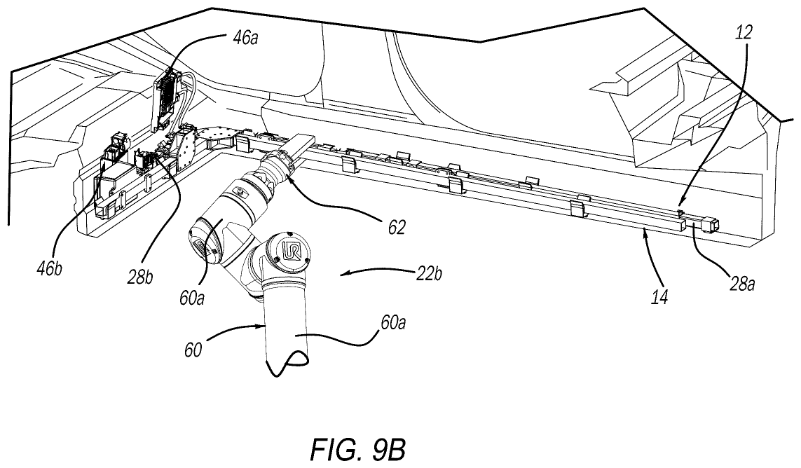

At 120, the control algorithm, using the controller 26, instructs the robot 22b to align the vehicle modules 46a, 46b and the vehicle component 12 to the machine 17 (FIG. 8). It should be understood that the vision sensors 64b and the sensors 66b may facilitate alignment of the vehicle modules 46a, 46b and the vehicle component 12 to the machine 17. At 124, the control algorithm, using the controller 26, instructs the robot 22b to move the rigid structure 70 in a predetermined pattern to decouple the vehicle modules 46a, 46b and the vehicle component 12 from the fixture 14 and couple the vehicle modules 46a, 46b and the vehicle component 12 to the machine 17 (FIGS. 9A and 9B). It should be understood that the decoupling of the vehicle modules 46a, 46b and the vehicle component 12 from the fixture 14 and the coupling of the vehicle modules 46a, 46b and the vehicle component 12 to the machine 17 may occur simultaneously. The coupling of the vehicle modules 46a, 46b and the vehicle component 12 to the machine 17 may include mounting the vehicle modules 46a, 46b and the vehicle component 12 to mounting features onto the machine 17. In one form, the mounting features may include apertures or slots formed in the machine 17. In this way, protrusions, pins and/or tabs on the vehicle modules 46a, 46b and the collars 31 on the vehicle component 12 may be securely received in the mounting features of the machine 17 to attach the vehicle modules 46a, 46b and the vehicle component 12 to the machine 17.

In the example illustrated, the vehicle modules 46a, 46b and the section 28b may be attached to a first location of the machine 17 and the section 28a may be attached to a second location of the machine 17 that is different from the first location. For example, the first location may be a rear area of the machine 17 and the second location may be a side area (e.g., rocker or sill) of the machine 17. The vehicle modules 46a, 46b and the section 28b may be attached to the first location of the machine 17 prior to attaching the section 28a to the second location of the machine 17. In this way, the control algorithm, using the controller 26, instructs the robot 22b to move the rigid structure 70 in a first predetermined pattern to attach the vehicle modules 46a, 46b and the section 28b to the first location and then instructs the robot 22b to move the rigid structure 70 in a second predetermined pattern to attach the section 28a to the second location. In some forms, the vehicle modules 46a, 46b and the sections 28a, 28b may be attached to the machine 17 simultaneously. In other forms, the rigid structure 70 may include other components that are attached to the machine 17 in a predetermined order.

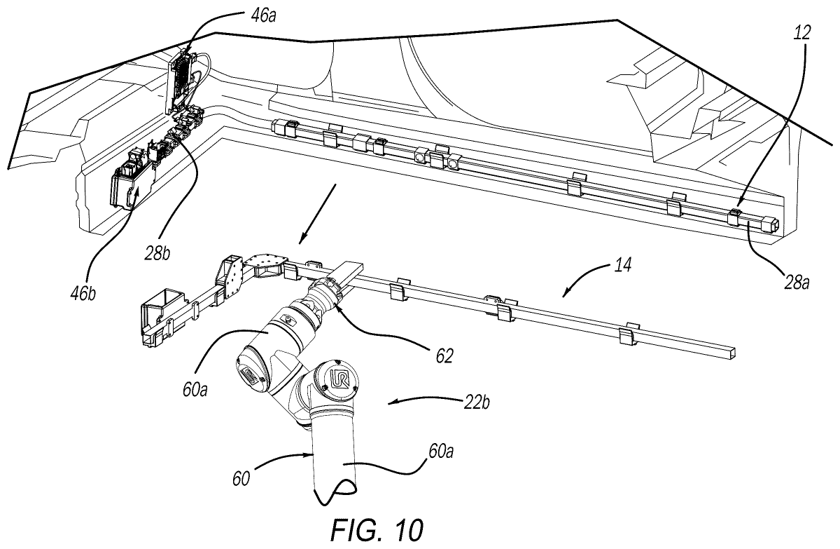

At 128, the control algorithm, using the controller 26, instructs the robot 22b to remove the fixture 14 from the machine 17 (FIG. 10). The robot 22b may move the fixture 14 back to the work surface 16 where another vehicle component is connected thereto, thereby repeating the process again. Although the system 10 discloses two robots 22a, 22b (i.e., the robot 22a for unfolding the sections 28a, 28b of the vehicle component 12 and connecting electrical components 21 to the modules 46a, 46b, and the robot 22b for moving the structure 70 to the machine 17), the system 10 may include one robot that performs the desired functions.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for installing a wiring harness into a vehicle, the method comprising:
coupling at least one module and the wiring harness to a fixture to form a structure;
moving the structure to the vehicle;
decoupling the at least one module and the wiring harness from the fixture;
coupling the at least one module and the wiring harness to the vehicle; and
removing the fixture from the vehicle.

2. The method of claim 1, wherein decoupling the at least one module and the wiring harness from the fixture and coupling the at least one module and the wiring harness to the vehicle occur simultaneously.

3. The method of claim 1, further comprising connecting at least one connector of the wiring harness to at least one terminal of the at least one module prior to moving the structure to the vehicle.

4. The method of claim 1, further comprising aligning the wiring harness and the at least one module within the vehicle after moving the structure to the vehicle.

5. The method of claim 1, wherein the structure is a rigid structure.

6. The method of claim 1, wherein coupling the at least one module and the wiring harness to the vehicle includes mounting the at least one module and the wiring harness to mounting features of the vehicle.

7. The method of claim 1, wherein:
coupling the at least one module and the wiring harness to the fixture occurs at a first location; and
coupling the at least one module and the wiring harness to the vehicle occurs at a second location, wherein the first location is different than the second location.

8. The method of claim 1, wherein coupling the at least one module and the wiring harness to the vehicle includes coupling the at least one module and a first portion of the wiring harness to a first location of the vehicle and coupling a second portion of the wiring harness to a second location of the vehicle after the at least one module and the first portion of the wiring harness has been coupled to the first location of the vehicle.

9. The method of claim 8, wherein the first location of the vehicle is a rear region of the vehicle and the second location of the vehicle is a side region of the vehicle.

10. A method for installing a wiring harness into a vehicle, the method comprising:
coupling a plurality of modules and the wiring harness to a fixture to form a rigid structure;
moving the rigid structure to the vehicle;
decoupling the plurality of modules and the wiring harness from the fixture;
coupling the plurality of modules and the wiring harness to the vehicle; and
removing the fixture from the vehicle,
wherein coupling the plurality of modules and the wiring harness to the vehicle includes coupling the plurality of modules and a first portion of the wiring harness to a first location of the vehicle and coupling a second portion of the wiring harness to a second location of the vehicle.

11. The method of claim 10, wherein decoupling the plurality of modules and the wiring harness from the fixture and coupling the plurality of modules and the wiring harness to the vehicle occur simultaneously.

12. The method of claim 10, further comprising connecting at least one connector of the wiring harness to a corresponding terminal of one module of the plurality modules prior to moving the rigid structure to the vehicle.

13. The method of claim 10, further comprising aligning the wiring harness and the plurality of modules within the vehicle after moving the rigid structure to the vehicle.

14. The method of claim 10, wherein coupling the plurality of modules and the wiring harness to the vehicle includes mounting the plurality of modules and the wiring harness to mounting features of the vehicle.

15. The method of claim 10, wherein the first location is different than the second location.

16. The method of claim 10, wherein the second portion of the wiring harness is coupled to the second location of the vehicle after the plurality of modules and the first portion of the wiring harness has been coupled to the first location of the vehicle.

17. A system for installing a wiring harness into a vehicle, the system comprising:
a fixture including at least one module coupled thereto;
at least one robot; and
a controller in communication with the at least one robot, the controller configured to:
instruct the at least one robot to couple the wiring harness to the fixture including the at least one module to form a structure;
instruct the at least one robot to move the structure to the vehicle;
instruct the at least one robot to decouple the at least one module and the wiring harness from the fixture;
instruct the at least one robot to couple the at least one module and the wiring harness to the vehicle; and
instruct the at least one robot to move the fixture from the vehicle.

18. The system of claim 17, wherein the structure is a rigid structure.

19. The system of claim 17, wherein the at least one robot comprises a first robot configured to couple the wiring harness to the fixture, and a second robot configured to move the structure to the vehicle.

20. The system of claim 17, wherein coupling the at least one module and the wiring harness to the vehicle includes coupling the at least one module and a first portion of the wiring harness to a first location of the vehicle and coupling a second portion of the wiring harness to a second location of the vehicle after the at least one module and the first portion of the wiring harness has been coupled to the first location of the vehicle.
